(19) United States
(12) Patent Application Publication
(10) Pub. No.: US 2015/0014248 A1
(43) Pub. Date: Jan. 15, 2015

(54) METHOD AND SYSTEM FOR GENERATING STRONG BRINES

(71) Applicant: Hydration Systems, LLC, Scottsdale, AZ (US)

(72) Inventors: John R. Herron, Corvallis, OR (US); Edward Beaudry, Corvallis, OR (US); Keith A. Lampi, Corvallis, OR (US)

(21) Appl. No.: 14/329,027

(22) Filed: Jul. 11, 2014

Related U.S. Application Data
(60) Provisional application No. 61/846,155, filed on Jul. 15, 2013.

(51) Int. Cl. B01D 61/58; B01D 61/00; C02F 1/44; B01D 61/02

(52) U.S. Cl. CPC B01D 61/58; B01D 61/025; B01D 61/027; B01D 61/002; C02F 1/441; C02F 1/442; C02F 1/445; B01D 2317/08; C02F 2103/08
USPC 210/641; 210/252

(57) ABSTRACT

Methods and systems for generating strong brines are disclosed in which a feed stream and a draw inlet stream are passed through a forward osmosis membrane to create a concentrate and a draw outlet stream, the draw outlet stream is passed through a reverse osmosis membrane to create a reverse osmosis permeate flow and a reverse osmosis retentate flow, the reverse osmosis retentate flow is passed through a first nanofiltration membrane to create a first nanofiltration permeate flow and a first nanofiltration retentate flow; and the first nanofiltration retentate flow is passed through a second nanofiltration membrane to create a second nanofiltration permeate flow and a second nanofiltration retentate flow. In some embodiments, the process is repeated through a third nanofiltration membrane. The process may be repeated through a third nanofiltration membrane.

### CROSS REFERENCE TO RELATED APPLICATIONS

This non-provisional application claims priority based upon prior U.S. Provisional Patent Application Ser. No. 61/846,155 filed Jul. 15, 2013 in the name of John Herron, Edward Beaudry and Keith Lampi, entitled “PROGRESSIVE HIGH PRESSURE REVERSE OSMOSIS-NANOFILTRATION FOR GENERATION OF STRONG BRINES,” the disclosure of which is incorporated herein by reference.

### BACKGROUND OF THE INVENTION

Reverse osmosis is a very useful technology for dewatering salt solutions such as seawater, however reverse osmosis is unable to dewater solutions of higher salinity for reasons that are widely known. Very saline brines are typically dewatered with thermal processes which are energy intensive and constructed from expensive exotic metals.

The need for dewatering salt brines has recently become much more pressing due to the wastewaters associated with the development of gas and oil extraction. In many areas the geology is not appropriate for reinjection of water, so wastewater from oil and gas production needs to be cleaned for discharge or transported great distances for disposal. Cleaning the water is difficult and expensive particularly in regions where the “produced” water coming up with the oil and gas is saline. Processes which can separate dischargeable water from the saline solution are attractive since they can reduce trucking and disposal costs.

One method for dewatering produced water is to run the water through a series of treatments such as lime softening, dissolved air flotation, electrocoagulation, sand filtration and ultrafiltration, then to introduce the clean saline solution to a reverse osmosis concentrator if the salt concentration is low or to an evaporator/crystallizer if the concentration is high. In situations in which reverse osmosis is used, salt concentrations in the processed waste are generally limited to a maximum of about 8%.

### Previous Membrane Systems for High Brine Concentration

It has long been recognized that the osmotic effect on flux through a membrane is based on the difference in the osmotic potential between the fluids on the two sides of the membrane. For example, U.S. Pat. No. 7,144,511, entitled “Two Stage Nanofiltration Seawater Desalination System,” describes how the osmotic resistance of seawater applied to a nanofiltration membrane is lower than the osmotic potential of the seawater because the permeate has salt and therefore has an osmotic potential.

### Theory of Brine Concentration by Nanofiltration

Reverse osmosis membrane systems extract fresh water from salt brines by applying pressure to the brine which exceeds the osmotic pressure of the solution. The osmotic pressure of brines is expressed by the Van't Hoff equation:

π=icRT

Where π is the osmotic pressure, i is the Van't Hoff factor (≈2 for NaCl), c is the concentration in mol/L, R is the gas constant (0.0831451 bar*L/(mol*K), and T is the absolute temperature in degrees Kelvin.

The osmotic limit to which a reverse osmosis system can remove water from a salt brine is expressed as follows:

π=P

where P is the applied pressure. Most reverse osmosis desalination membrane systems are limited to applied pressures of around 70 bar so they are unable to remove water from solutions with osmotic potentials higher than 70 bar, which is around 3 molar ionic species concentration (e.g., 8% NaCl solution).

If there were salt on both sides of the membrane, the 8% salt limit could be exceeded in a reverse osmosis vessel. The water removal limit would then be expressed as follows:

π_{f}=πₚ=P

where P is the applied pressure, π_{f} is the osmotic pressure on the feed side of the membrane and πₚ is the osmotic pressure on the permeate side. As an example, if the permeate solution in a 70 bar reverse osmosis element was 2% NaCl the feed solution could be concentrated to about 10% NaCl.

It would seem reasonable to try to introduce the salt solution to the permeate side of the membrane by pumping a salt brine in a cross-flow manner through the permeate side of the element, but in reality this is not particularly effective. The problem arises from what is termed internal concentration polarization. Reverse osmosis membranes are asymmetric, that is they have a very thin skin (less than 200 nm thick) which does all the salt rejection. For the salt solution on the permeate side to affect osmosis, it is the concentration at the permeate-side surface of the rejection layer that is meaningful. This concentration will be less than that in the solution which is pumped through the permeate channel because the rejection layer is supported by a porous plastic layer which is in turn supported by a nonwoven fabric. Reverse osmosis membranes have very high salt rejection, so any water crossing the membrane will be fresh and will wash salt out of the porous and nonwoven supports. For the permeate salt to return to the rejection layer it must diffuse back, which is a very slow process due to the dense nature of high-pressure reverse osmosis support layers.

Another method of introducing salt to the permeate side of a membrane rejection layer is to let the salt permeate through the membrane from the feed solution. Nanofiltration membranes impede salt permeation without completely stopping it, so in a situation where the osmotic pressure of the feed is greater than the applied pressure, salt passing through the membrane will carry water with it. Assuming the solution-diffusion model is a reasonable approximation for transport in the nanofiltration membrane at these pressures and osmotic potentials, the equation for the water flux is

v_{w}=A(ΔP−Δπ)=A(P−(π_{f}−πₚ))=A(P+πₚ−π_{f}),

where v_{w} is the water flux in LMH (L/(m²h) or liters of water traversing each square meter of membrane each hour), A is the membrane hydraulic permeability in LMH/bar, ΔP is the hydraulic pressure across the membrane (feed−permeate or P−0=P), and Δπ is the osmotic pressure across the membrane rejection layer (feed−permeate or π_{f}−πₚ). To achieve a positive flux of water when the osmotic pressure of the feed (π_{f}) exceeds the applied pressure (P), enough salt must be allowed across the membrane, so that the permeate osmotic pressure (πₚ) plus the applied pressure (P) exceeds the feed osmotic pressure (π_{f}).

In the solution-diffusion model, the equation that governs the salt flux is as follows:

Nₛ=BΔc=B(c_{f}−cₚ),

where Nₛ is the salt flux in mol/(m²h), B is the membrane salt permeability coefficient in LMH, and Δc is the concentration difference across the membrane rejection layer (feed−permeate or c_{f}−cₚ).

The final equation to estimate the performance is to realize that the concentration of the permeate is approximately equal to the salt flux divided by the water flux, or

cₚ≈Nₛ/v_{w}.

The Van't Hoff equation can be utilized to relate the concentrations to the osmotic pressure, which results in the following solution to the quadratic equation:

v_{w}=−b+(b²−c_{q})^{1/2}

where

b=(B−A*P+AiRTc_{f})/2=(B−A*(P−π_{f}))/2, and

c_{q}=−A*B*P.

The permeate concentration is expressed as follows:

cₚ=B*c_{f}/(B+v_{w})

As an example, assume:

A=3.0 LMH

B=1.0 LMH

c_{f}=1.6 mol/L NaCl

π_{f}=79 bar

P=70 bar

Then v_{w}=6.0 LMH and the concentration of the permeate is 0.23 mol/L or 13 g/L NaCl.

The permeate has a lower salt concentration than the feed so the feed will become more saline. As the salinity goes up the π_{f} value increases so that, for a given B, v_{w} will decrease rapidly.

It is possible to maintain water fluxes as the salinity increases by introducing the solution to membranes with successively higher salt flux values.

It can be seen from the equations that the separation in osmotic potential between the feed and the permeate is directly proportional to the applied pressure, so it is advantageous to apply as high a pressure as practical in order to minimize the volume of feed and the number of membrane elements required. Pressures of 1000 to 1200 psi are easily achieved using standard reverse osmosis element housings and pumps.

### Scaling and Fouling in Progressive Nanofiltration

The ability to generate strong salt solutions with nanofiltration has been recognized for years, however commercial application has rarely been pursued because of scaling and fouling issues. A technology to remove as much water as possible from salty streams is of most interest in processing wastewaters such as landfill leachate or oil and gas production effluent. However, these waters tend to be highly fouling and, even with extensive pretreatment, they tend to foul reverse osmosis or nanofiltration systems. This has been documented in numerous publications such as “Analysis of CaSO₄ Scale Formation Mechanism in Various Nanofiltration Modules” in the Journal of Membrane Science, 1999, “Fouling in Nanofiltration” in Nanofiltration—Principles and Applications, Elsevier, Chapter 20, 169-239, and “Treatment of Severely Contaminated Waste Water by a Combination of RO, high-pressure RO and NF—Potential and Limits of the Process” in Journal of Membrane Science, 2000.

It would, therefore, be desirable to have methods and systems for concentrating saline solutions to higher concentrations than those achievable by reverse osmosis alone while removing fouling and scaling species from the waste stream before introducing the stream to the progressive nanofiltration elements.

### SUMMARY OF THE INVENTION

The present invention provides a method and system for generating strong brines in which a feed stream and a draw inlet stream are passed through forward osmosis membrane elements to create a concentrate and a draw outlet stream, the draw outlet stream is passed through reverse osmosis membrane elements to create a reverse osmosis permeate flow and a reverse osmosis retentate flow, the reverse osmosis retentate flow is passed through a first nanofiltration membrane element to create a first nanofiltration permeate flow and a first nanofiltration retentate flow, and the first nanofiltration retentate flow is passed through a second nanofiltration membrane element to create a second nanofiltration permeate flow and a second nanofiltration retentate flow. In some embodiments, the process is repeated through a third nanofiltration membrane element.

In some embodiments, the draw outlet stream is passed through a nanofiltration membrane to clean the stream before passing through the reverse osmosis membrane. The nanofiltration membrane removes scale and contaminants from the draw outlet stream. The permeate from this nanofiltration membrane becomes the feed stream for the reverse osmosis membrane and the retentate is blended with the forward osmosis feed stream.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a flow diagram showing one embodiment of a method and apparatus to concentrate brines utilizing a reverse osmosis membrane and multiple nanofiltration membranes;

FIG. 2 is a flow diagram showing another embodiment of a method and apparatus to concentrate brines utilizing a reverse osmosis membrane and multiple nanofiltration membranes;

FIG. 3 is a flow diagram showing another embodiment of a method and apparatus to concentrate brines utilizing a reverse osmosis membrane and multiple nanofiltration membranes with the addition of a forward osmosis membrane and a nanofiltration draw clean-up; and

FIG. 4 is a flow diagram showing another embodiment of a method and apparatus to concentrate brines utilizing a reverse osmosis membrane and multiple nanofiltration membranes with the addition of a forward osmosis membrane and a nanofiltration draw clean-up.

### DESCRIPTION OF THE PREFERRED EMBODIMENTS

The present invention is directed to improved methods and systems for, among other things, the generation of strong brines. The configuration and use of the presently preferred embodiments are discussed in detail below. It should be appreciated, however, that the present invention provides many applicable inventive concepts that can be embodied in a wide variety of contexts other than the generation of brines. Accordingly, the specific embodiments discussed are merely illustrative of specific ways to make and use the invention, and do not limit the scope of the invention. In addition, the following terms shall have the associated meaning when used herein:

“forward osmosis” includes any fluid purification technology that uses osmotic pressure to pass fluid through a membrane;

“nanofiltration” includes any fluid purification technology that uses membranes to impede, but not prevent, the passage of a desired species; and

“reverse osmosis” includes any fluid purification technology that produces a fresh water permeate by using an applied pressure to overcome osmotic pressure.

Reverse osmosis is a process that is reversed from the naturally occurring process of osmosis. Osmosis occurs when solutions of differing concentrations are separated by a semi-permeable membrane. The osmotic pressure across the membrane is directly proportional to the difference in concentration between the two solutions. To overcome osmosis, pressure must be applied to the more concentrated solution to counteract the natural osmotic pressure being exerted upon it. To reverse the direction of the natural osmotic flow, additional pressure is required.

The process of dewatering brines by reverse osmosis has been developed primarily for seawater desalination. In this application, a solution of primarily sodium chloride at approximately 3.5 wt % is contacted under pressure to a semipermeable membrane. The semipermeable membrane is highly selective, allowing water to pass while almost entirely blocking salt passage. The pressure needed to overcome the osmotic draw of seawater is about 30 bar and no freshwater is produced at applied pressures below this. In practice, since the osmotic pressure of the seawater increases as water is removed, pressures of up to 70 bar are used. Seawater reverse osmosis produces two streams: a freshwater permeate and a brine concentrate at approximately 6 wt %.

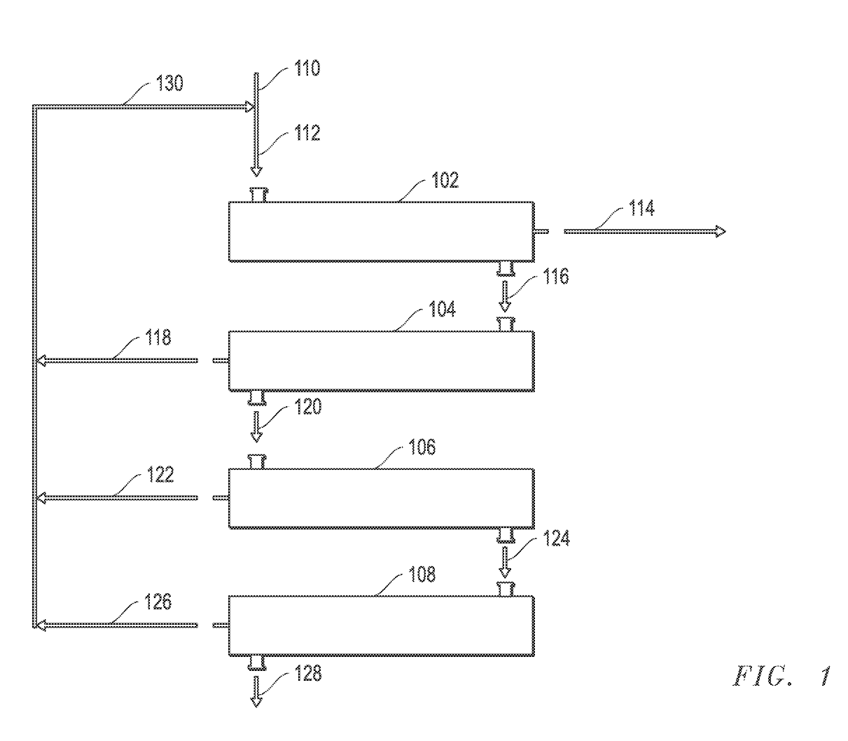

One embodiment of the present invention of the method and system for concentrating brine is shown in FIG. 1, wherein a clean feed of brine 110 enters a seawater type reverse osmosis filter 102. In one embodiment, the feed of brine 110 may be approximately 60 grams/liter, or six percent, sodium chloride at 100 liters/minute. When combined with the combined permeate streams 130 from the progressive nanofiltration filters described below, the combined feed stream 112 has a slightly lower salinity. For example, if the combined permeate streams 130 have a salinity of 31.67 grams/liter at 60 liters/min, the combined feed stream 112 will have a salinity of approximately 49 grams/liter at 160 liters/minute.

Devices and filters for reverse osmosis known in the art may be used in the present invention. If a spiral-wound membrane is used, the membrane housing may contain up to 8 spiral elements. The combined feed stream 112 is pressurized and passes through the reverse osmosis filter 102 resulting in a permeate 114 which is substantially desalinated and a retentate 116 with a higher salinity. Using the example from above in which the combined feed stream 112 has a salinity of approximately 49 grams/liter at 160 liters/minute, the permeate 114 from the reverse osmosis filter 104 may have a very low or negligible salinity, such as that of potable water, at 60 liters/minute and the retentate 116 may have a salinity of approximately 80 grams/liter at 100 liters/minute.

Retentate 116 is then fed into first nanofiltration filter 104. Devices and filters for nanofiltration known in the art may be used in the present invention. If a spiral-wound membrane is used, the membrane housing may contain up to eight spiral elements, and the solute permeability coefficient B for the membrane first nanofiltration filter 104 may, for example, be 1. Retentate 116 passes through the first nanofiltration filter 104, again resulting in a permeate 118 with a lower salinity and a retentate 120 with a higher salinity. Using the example from above in which retentate 116 has a salinity of approximately 80 grams/liter at 100 liters/minute, the permeate 118 from the first nanofiltration filter 104 may have a salinity of approximately 10 grams/liter at 20 liters/minute and the retentate 120 may have a salinity of approximately 97.5 grams/liter at 80 liters/minute.

Retentate 120 from first nanofiltration filter 104 is then fed into second nanofiltration filter 106. Devices and filters for nanofiltration known in the art may also be used in second nanofiltration filter 106. If a spiral-wound membrane is used, the membrane housing may contain up to eight spiral elements, and the solute permeability coefficient B for the membrane second nanofiltration filter 106 may, for example, be 2.5. Retentate 120 passes through the second nanofiltration filter 106, again resulting in a permeate 122 with a lower salinity and a retentate 124 with a higher salinity. Using the example from above in which retentate 120 has a salinity of approximately 97.5 grams/liter at 80 liters/minute, the permeate 122 from the second nanofiltration filter 106 may have a salinity of approximately 30 grams/liter at 20 liters/minute and the retentate 124 may have a salinity of approximately 120 grams/liter at 60 liters/minute.

Retentate 124 from second nanofiltration filter 106 may then be fed into third nanofiltration filter 108. Devices and filters for nanofiltration known in the art may also be used in third nanofiltration filter 108. If a spiral-wound membrane is used, the membrane housing may contain up to 8 spiral elements, and the solute permeability coefficient B for the membrane third nanofiltration filter 108 may, for example, be 3.3. Retentate 124 passes through the third nanofiltration filter 108, again resulting in a permeate 126 with a lower salinity and a retentate 128 with a higher salinity. Using the example from above in which retentate 124 has a salinity of approximately 120 grams/liter at 60 liters/minute, the permeate 126 from the third nanofiltration filter 108 may have a salinity of approximately 55 grams/liter at 20 liters/minute and the retentate 128 may have a salinity of approximately 150 grams/liter at 40 liters/minute.

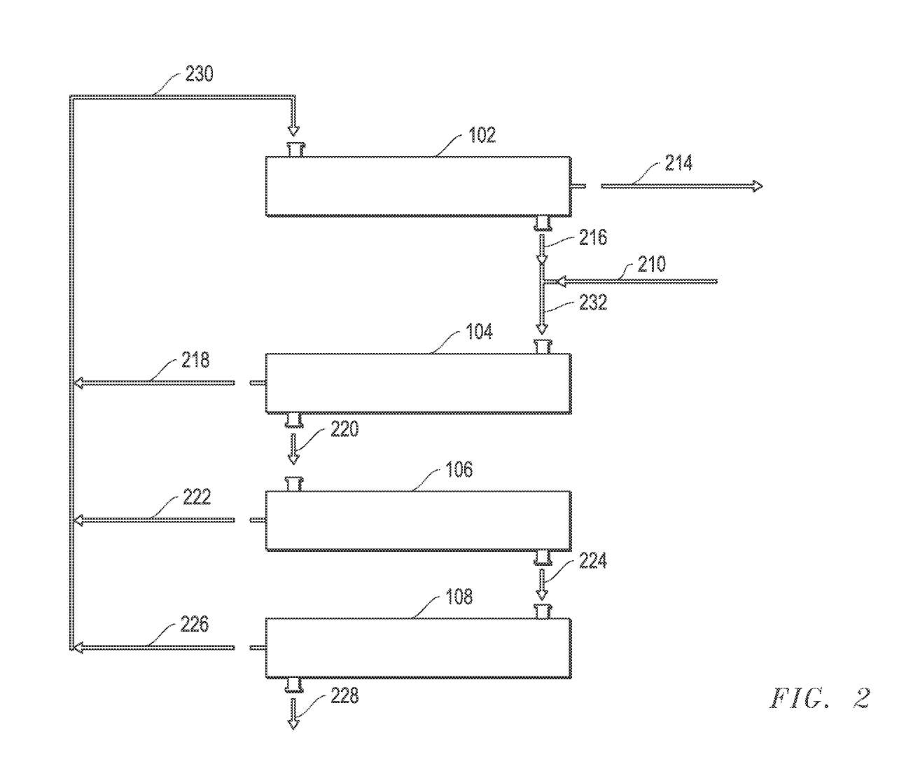

Those skilled in the art will appreciate that alternative embodiments and variants of the present invention may be useful under various operating conditions. For example, if feed stream 110 has an osmotic pressure above 60 bar it may be desirable to avoid passing the combined feed stream 112 through the reverse osmosis filter 102. Using the configuration shown in FIG. 2, the combined permeate streams 230 is pressurized and enters reverse osmosis filter 102. For example, the combined permeate streams 230 may be approximately 32 grams/liter sodium chloride at 60 liters/minute and, after passing through reverse osmosis filter 102, may result in a permeate 214 with a very low or negligible salinity, such as that of potable water, at 36 liters/minute and the retentate 216 may have a salinity of approximately 80 grams/liter at 24 liters/minute.

Retentate 216 is then combined with pressurized feed stream 210 to form combined feed stream 232. If, for example, feed stream 210 has a salinity of 80 grams/liter at 76 liters/minute, the resulting combined feed stream 232 will have a salinity of 80 grams/liter at 100 liters/minute.

Combined feed stream 232 then passes through first nanofiltration filter 104. As in the previous embodiment, devices and filters for nanofiltration known in the art may be used and, if a spiral-wound membrane is used, the membrane housing may contain up to 8 spiral elements, and the solute permeability coefficient B for the membrane first nanofiltration filter 104 may, for example, be 1. Combined feed stream 232 passes through the first nanofiltration filter 104, again resulting in a permeate 218 with a lower salinity and a retentate 220 with a higher salinity. If the salinity of the combined feed stream 232 is approximately 80 grams/liter at 100 liters/minute, the permeate 218 from the first nanofiltration filter 104 may have a salinity of approximately 10 grams/liter at 20 liters/minute and the retentate 220 may have a salinity of approximately 97.5 grams/liter at 80 liters/minute.

Retentate 220 from first nanofiltration filter 104 is then fed into second nanofiltration filter 106. If a spiral-wound membrane is used, the membrane housing may contain up to 8 spiral elements, and the solute permeability coefficient B for the membrane second nanofiltration filter 106 may, for example, be 2.5. Retentate 220 passes through the second nanofiltration filter 106, again resulting in a permeate 222 with a lower salinity and a retentate 224 with a higher salinity. Using the example from above in which retentate 220 has a salinity of approximately 97.5 grams/liter at 80 liters/minute, the permeate 222 from the second nanofiltration filter 106 may have a salinity of approximately 30 grams/liter at 20 liters/minute and the retentate 224 may have a salinity of approximately 120 grams/liter at 60 liters/minute.

Retentate 224 from second nanofiltration filter 106 may then be fed into third nanofiltration filter 108. If a spiral-wound membrane is used, the membrane housing may contain up to 8 spiral elements, and the solute permeability coefficient B for the membrane third nanofiltration filter 108 may, for example, be 3.3. Retentate 224 passes through the third nanofiltration filter 108, again resulting in a permeate 226 with a lower salinity and a retentate 228 with a higher salinity. Using the example from above in which retentate 224 has a salinity of approximately 120 grams/liter at 60 liters/minute, the permeate 226 from the third nanofiltration filter 108 may have a salinity of approximately 55 grams/liter at 20 liters/minute and the retentate 228 may have a salinity of approximately 150 grams/liter at 40 liters/minute.

The progressive nanofiltration method and system described above may be implemented using a variety of devices and filters and under varying amounts of pressure. In addition, the reverse osmosis and nanofiltration systems may be configured together or the elements may be separate and, for example, have independent pumps.

As with any reverse osmosis or nanofiltration system, material being removed from the feed stream can accumulate on the membrane which results in scaling and fouling and the loss of production capacity. This is particularly true when utilizing reverse osmosis and nanofiltration membranes with spiral-wound designs because high-production elements have very narrow feed channels and the feed spacers induce dead spots which collect solids.

In another embodiment of the present invention, the feed is filtered through a forward osmosis membrane to control scaling and fouling. The forward osmosis process works by contacting one side of a semipermeable membrane with the feed solution and the other side with a draw solution with an osmotic potential. Water permeates the membrane from the feed into the draw due to the difference in osmotic pressures. Since the forward osmosis membrane blocks the fouling and scaling species, forward osmosis draw solutions can have their chemistry controlled to avoid fouling and the diluted draw solution from the forward osmosis elements can be reconcentrated by progressive nanofiltration. The forward osmosis process is inherently much less impacted by fouling or scaling species so it can concentrate wastewaters inappropriate for pressure filtration such as reverse osmosis or nanofiltration.

In general, there is a slow migration of scaling species through the forward osmosis membrane, but build-up of scaling species can be controlled by a separate nanofiltration cleaning membrane system on the draw solution loop. If a sodium chloride draw solution is filtered with a nanofiltration element which retains silica and multivalent cations while passing monovalent cations, scaling species which permeate the forward osmosis membrane can be returned to the forward osmosis feed.

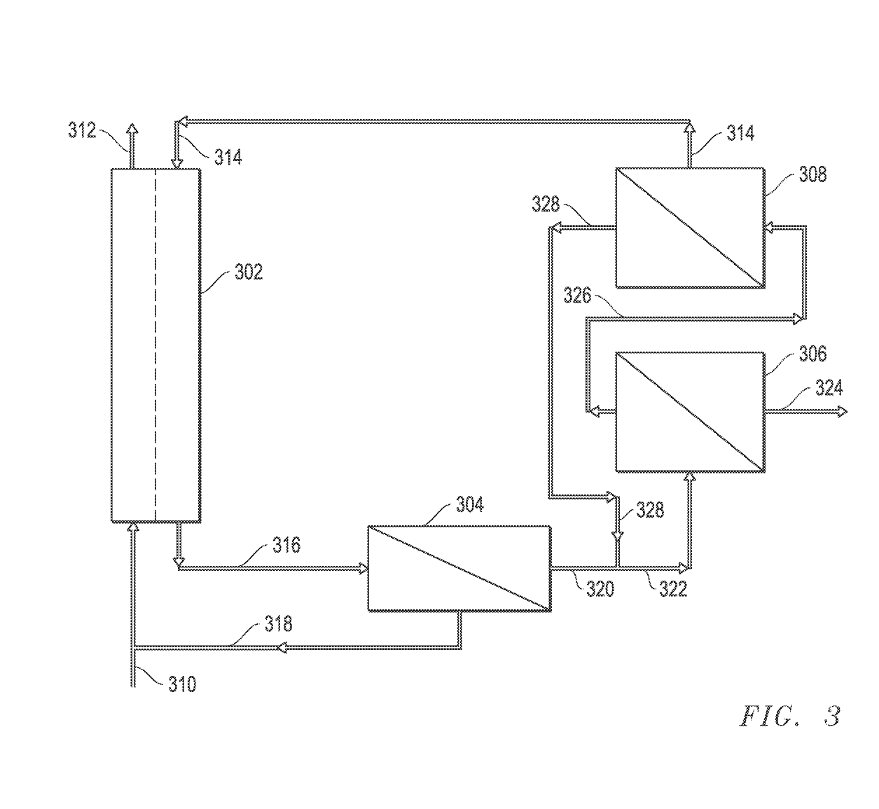

As shown in FIG. 3, a feed stream 310 enters forward osmosis filter 302 resulting in a concentrate 312 of higher salinity while a counterflowing draw 314 enters forward osmosis filter 302 resulting in an exiting draw stream 316 of lower salinity. For example, if feed stream 310 has a salinity of approximately 50 grams/liter and draw stream 314 has a salinity of approximately 120 grams/liter, concentrate 312 would have a concentration of approximately 100 grams/liter and exiting draw stream 316 would have a salinity of approximately 70 grams/liter. Of course, these salinity values are meant to be for illustration only and are not limiting.

As discussed above, the exiting draw stream 316 may be passed through a nanofiltration filter 304 to remove build-up of scaling species, such as silica, and multivalent cations. After scalants are removed, the scalant-free draw 320 leaves the nanofiltration filter 302 and the scalant-containing draw purge 318 is recycled into feed stream 310. This nanofiltration of the draw 316 exiting the forward osmosis filter 302 allows the system to operate in steady state with less maintenance and for longer periods than other reverse osmosis and nanofiltration systems known in the art.

The scalant-free draw 320 is combined with the nanofiltration permeate and passed into a reverse osmosis system in the same manner as described above and shown in FIGS. 1 and 2. The scalant-free draw 322 is pressurized and passes through the reverse osmosis filter 306 resulting in a desalinated permeate 324 and a retentate 326 with a higher salinity. The salinities of the permeate and the retentate may be similar to those described in the above examples. Retentate 326 is then fed into a series of progressive nanofiltration filters 308 in the same manner as described above. Permeate 328 is recycled and blended with the scalant free draw 320 and the draw 314 is passed through the forward osmosis filter 302 to concentrate more feed.

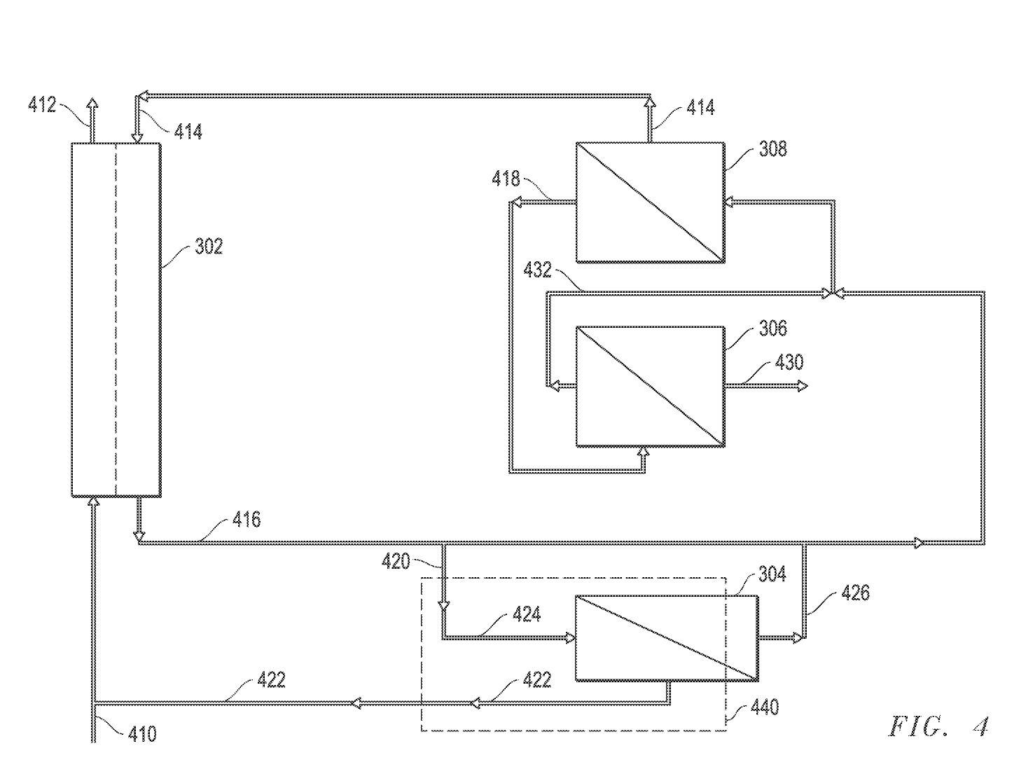

Once again, those skilled in the art will appreciate that alternative embodiments and variants of the present invention may be useful under various operating conditions. For example, FIG. 4 shows a flow diagram showing another embodiment of a method and apparatus to concentrate brines utilizing a reverse osmosis filter 306 and progressive nanofiltration filters 308 with the addition of a forward osmosis membrane 302 and a nanofiltration draw clean-up 302.

A feed stream 410 enters forward osmosis filter 302 resulting in a concentrate 412 of higher salinity while a counterflowing draw 414 enters forward osmosis filter 302 resulting in an exiting draw stream 416 of lower salinity. This configuration is similar to the configuration shown in FIG. 3. However, the exiting draw stream 416 has only a portion of its flow filtered to remove scalants.

In this embodiment, the reverse osmosis and nanofiltration are configured in a similar manner as FIG. 2. Permeate from the nanofiltration scale removing element 426, blended with exiting draw stream 416, and the retentate from the RO elements is pressurized and passes into the progressive nanofiltration filters 308 creating a draw 414 and a permeate 418. The permeate 418 is used as a feed stream to reverse osmosis filter 306 creating a substantially saline-free permeate 430 and a retentate 432 that is blended with the feed stream for the progressive nanofiltration filters 408.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for producing strong brines known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for generating high osmotic strength solutions, comprising:
passing a feed stream and a draw inlet stream through a forward osmosis membrane to create a concentrate and a draw outlet stream;
passing the draw outlet stream through a reverse osmosis membrane to create a reverse osmosis permeate flow and a reverse osmosis retentate flow;
passing the reverse osmosis retentate flow through a first nanofiltration membrane to create a first nanofiltration permeate flow and a first nanofiltration retentate flow; and
passing the first nanofiltration retentate flow through a second nanofiltration membrane to create a second nanofiltration permeate flow and a second nanofiltration retentate flow.

2. The method of claim 1, further including passing the second nanofiltration retentate flow through a third nanofiltration membrane to create a third nanofiltration permeate flow and a third nanofiltration retentate flow.

3. The method of claim 1, wherein, prior to passing through the reverse osmosis membrane, at least a portion of the draw outlet stream is passed through a nanofiltration membrane to create a retentate stream and a permeate stream, wherein the permeate stream is passed through the reverse osmosis membrane in lieu of, or in addition to, the draw outlet stream and the retentate stream is blended with the feed stream.

4. The method of claim 1, wherein salinity of the feed stream is about 50 grams/liter.

5. The method of claim 1, wherein salinity of the concentrate is about 100 grams/liter.

6. The method of claim 1, wherein the second nanofiltration permeate flow passes to the reverse osmosis membrane and the reverse osmosis retentate flow is blended with the draw inlet stream and passes to the first nanofiltration membrane.

7. The method of claim 1, wherein solute permeability coefficient B of the first nanofiltration membrane is approximately 1 and solute permeability coefficient B of the second nanofiltration membrane is approximately 2.5.

8. The method of claim 1, wherein the first nanofiltration membrane consists of a membrane having a different salt permeability than the second nanofiltration membrane.

9. The method of claim 1, wherein the second nanofiltration retentate flow is used as all or part of the draw inlet stream.

10. The method of claim 1, wherein the first nanofiltration membrane and the second nanofiltration membrane have applied pressures of between 40 and 200 bar.

11. The method of claim 1, wherein the first nanofiltration membrane and the second nanofiltration membrane have applied pressures of between 70 and 100 bar.

12. A system for generating high osmotic strength solutions, comprising:
a feed stream and a draw inlet stream that pass through a forward osmosis membrane to create a concentrate and a draw outlet stream;
a reverse osmosis membrane through which the draw outlet stream passes to create a reverse osmosis permeate flow and a reverse osmosis retentate flow;
a first nanofiltration membrane through which the reverse osmosis retentate flow passes to create a first nanofiltration permeate flow and a first nanofiltration retentate flow; and
a second nanofiltration membrane through which the first nanofiltration retentate flow passes to create a second nanofiltration permeate flow and a second nanofiltration retentate flow.

13. The system of claim 12, further including passing the second nanofiltration retentate flow through a third nanofiltration membrane to create a third nanofiltration permeate flow and a third nanofiltration retentate flow.

14. The system of claim 12, wherein, prior to passing through the reverse osmosis membrane, at least a portion of the draw outlet stream is passed through a nanofiltration membrane to create a retentate stream and a permeate stream, wherein the permeate stream is passed through the reverse osmosis membrane in lieu of the draw outlet stream and the retentate stream is blended with the feed stream.

15. The system of claim 12, wherein the salinity of the feed stream is about 50 grams/liter.

16. The system of claim 12, wherein the salinity of the concentrate is about 100 grams/liter.

17. The system of claim 12, wherein the second nanofiltration permeate flow passes to the reverse osmosis membrane and the reverse osmosis retentate flow is blended with the forward osmosis draw and passes to the first nanofiltration membrane.

18. The system of claim 12, wherein the solute permeability coefficient B of the first nanofiltration membrane is approximately 1 and the solute permeability coefficient B of the second nanofiltration membrane is approximately 2.5.

19. The system of claim 12, wherein the first nanofiltration membrane consists of a membrane having a different salt permeability tan the second nanofiltration membrane.

20. The system of claim 12, wherein the first nanofiltration membrane consists of a membrane having a different salt permeability than the second nanofiltration membrane and wherein the reverse osmosis retentate flow passes through a membrane with the lower salt permeability before passing through the other membrane.

21. The system of claim 12, wherein the second nanofiltration retentate flow is used as all or part of the draw inlet stream that through the forward osmosis membrane.

22. The system of claim 12, wherein the first nanofiltration membrane and the second nanofiltration membrane have applied pressures of between 40 and 200 bar.

23. The system of claim 12, wherein the first nanofiltration membrane and the second nanofiltration membrane have applied pressures of between 70 and 100 bar.
